(19) United States
(12) Patent Application Publication
(10) Pub. No.: US 2026/0008953 A1
(43) Pub. Date: Jan. 8, 2026

(54) BIO-TAR MITIGATION IN AQUIFER OR WATER INJECTORS WELLS

(71) Applicant: SAUDI ARABIAN OIL COMPANY, Dhahran (SA)

(72) Inventors: Abdulmohsen A. Al-Humam, Dammam (SA); Ayman R. Nakhli, Dammam (SA)

(73) Assignee: SAUDI ARABIAN OIL COMPANY, Dhahran (SA)

(21) Appl. No.: 19/334,548

(22) Filed: Sep. 19, 2025

Related U.S. Application Data
(62) Division of application No. 18/485,482, filed on Oct. 12, 2023.

(51) Int. Cl. C09K 8/582

(52) U.S. Cl. CPC C09K 8/582; C09K 2208/24

(57) ABSTRACT

Described is a method for mitigating tar in a reservoir. Tar-mitigating bacteria is introduced downhole to a reservoir with tar. The tar-mitigating bacteria are delivered to a tar food source in the reservoir, triggering bacterial growth upon reaching the tar food source. The tar breaks apart, allowing the tar-mitigating bacteria to produce and release biosurfactants, thereby trapping the tar from the reservoir with the biosurfactants. The tar trapped by the biosurfactants is mobilized away from porous rock, and the trapped tar is removed from the reservoir.

### BACKGROUND

In some oil reservoirs, tar may form a physical tar barrier that isolates producing zones from underground water sources. An underground water source may be natural, such as an aquifer, or it may be induced, such as a waterflood from a water injection well. Tar in the form of a physical tar barrier or “tar mat” may bar fluid flow in the reservoir either in full or in part. A full bar of fluid flow may be a complete separation between an oil reservoir and an underground water source. A partial bar of fluid flow may be a bottleneck between an oil reservoir and an underground water source.

Wells that traverse reservoirs having a physical tar barrier may result in decreased productivity or dead wells. The presence of a physical tar barrier in a reservoir may also cause poor sweep efficiency resulting in a substantial water cut increase, as compared to a well without a physical tar barrier.

Conventional treatments for dissolving or removing a physical tar barrier include, but are not limited to, introducing mineral acid solutions downhole to break up tar. Such conventional treatments may be corrosive to the reservoir, the wellbore, and equipment therein.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a composition of an aqueous fluid comprising an enriched substrate, tar-mitigating bacteria that produce biosurfactants and utilize tar as a food source, a nitrogen source, and a salt.

In another aspect, an initial concentration of produced biosurfactants is from 100 to 300 milligrams per liter in the total composition.

In another aspect, the tar-mitigating bacteria is one or more selected from the group consisting of genus Azobacter, Bacillus, Pseudomonas, and Rhodococcus.

In another aspect, the tar-mitigating bacteria is one or more selected from the group consisting of Azotobacter vinelandii, Bacillus subtilis, Psuedomonas aeruginosa, and Rhodococcus soli.

In another aspect, the nitrogen source includes one or more selected from the group consisting of a peptone and a yeast extract.

In another aspect, the salt is sodium chloride.

In another aspect, the composition is non-acidic, having a pH of from 7 to 12.

In one aspect, embodiments disclosed herein relate to a method for treating an oil reservoir. A composition comprising an aqueous fluid, a tar-mitigating bacteria, a nitrogen source, and a salt is introduced into a reservoir comprising tar.

In another aspect, the nitrogen source is one or more selected from the group consisting of a peptone and a yeast extract, and the salt is sodium chloride.

In another aspect, the reservoir comprising tar includes a physical tar barrier.

In another aspect, the tar-mitigating bacteria produce biosurfactants.

In another aspect, the biosurfactants are in a concentration of from 100 to 300 milligrams per liter in the total composition.

In another aspect, the tar-mitigating bacteria are a bacterial species that are native to the reservoir where they will be introduced.

In one aspect, embodiments disclosed herein relate to a method for mitigating tar in a reservoir. Tar-mitigating bacteria are introduced downhole to a reservoir comprising tar. The tar-mitigating bacteria are allowed to be delivered to a tar food source in the reservoir, triggering bacterial growth upon reaching the tar food source, whereupon the tar breaks apart. The tar-mitigating bacteria are allowed to produce and release biosurfactants, thereby trapping the tar from the reservoir with the biosurfactants. The tar trapped by the biosurfactants is mobilized away from porous rock, and the tar trapped by the biosurfactants is removed from the reservoir.

In another aspect, the tar food source that is the tar trapped within the reservoir is blocked from being ingested by the tar-mitigating bacteria.

In another aspect, a reservoir that comprises tar is identified.

In another aspect, the method for mitigating tar in a reservoir is performed at a temperature of from 4° C. to 100° C.

Other aspects and advantages of the claimed subject matter will be apparent from the following description and the appended claims.

### BRIEF DESCRIPTION OF DRAWINGS

FIG. 1 is an illustration of a well environment according to one or more embodiments.

FIG. 2 is a flow diagram illustrating a method for mitigating tar in a reservoir according to one or more embodiments.

FIG. 3 shows collection of a bacterial composition including the tar-mitigating bacteria according to one or more embodiments herein.

FIG. 4A shows a comparative example mixture of tar and oil prior to addition of a negative control, according to one or more embodiments.

FIG. 4B shows a comparative example mixture of tar and oil after addition of a negative control, according to one or more embodiments herein.

FIG. 5A shows an example mixture of tar and oil prior to introducing a composition according to one or more embodiments.

FIG. 5B shows an example mixture of tar and oil after introducing a composition according to one or more embodiments.

### DETAILED DESCRIPTION

One or more embodiments of the present disclosure relate to a microbial composition and biotreatment methods using such composition in a reservoir that mitigates a physical tar barrier that may separate an oil reservoir and an underground water source. Unlike other forms of tar mitigation, the composition and method according to one or more embodiments herein allows for less corrosion and an ability to mobilize tar to form a liquid tar.

### Composition

In one or more embodiments, a composition for biotreatment of a reservoir includes an aqueous fluid, a tar-mitigating bacteria, a nitrogen source, and a salt.

In one or more embodiments, the aqueous fluid includes a base component that is water. The base component of the aqueous fluid can be any form of water, including but is not limited to, fresh water, mineral water, synthetic, filtered and natural sea waters, brackish water, synthetic and natural brines, formation water, and production water. The water may contain a level of organics from natural or artificial sources as long as the function of the ionic liquid enhanced surfactant solution, which is to both modify the wettability of the hydrocarbon-bearing formation and to reduce interfacial tension between the water and the hydrocarbons present in the hydrocarbon-bearing formation, is not inhibited. The water may contain a level of minerals or metals from natural or artificial sources as long as the function of the ionic liquid enhanced surfactant solution is not inhibited. In one or more embodiments, the aqueous fluid comprises an enriched substrate, where the enriched substrate is glycerol.

### Tar-Mitigating Bacteria

Tar-mitigating bacteria are a component of the composition and have versatile metabolic capabilities of producing biomolecules. A tar-mitigating bacteria is a tar-eating bacteria that uses tar as a food source and produces biomolecules. In addition to utilizing tar as a food source, the tar-mitigating bacteria break up (disintegrate or metabolize) the tar into smaller parts.

The tar-mitigating bacteria have traits that allow them to thrive in conditions including high temperatures (up to 100° C.) and non-acidic pH, while using tar as a food source. The biomolecules produced by growing tar-mitigating bacteria include biosurfactants. Thus, the tar-mitigating bacteria's use downhole may allow for the in-situ production of biosurfactants within the reservoir. Such biosurfactants may trap and mobilize oil within the reservoir, thereby resulting in a produced liquid tar.

Any of the following genus or species of tar-mitigating bacteria may be included in one or more embodiments, so long as a strain of the species possesses tar-mitigating traits and produces biosurfactants.

The tar-mitigating bacteria may include one or more of the following: a species from the genus Azobacter, such as Azotobacter vinelandii; a species from the genus Bacillus, such as Bacillus subtilis; a species from the genus Pseudomonas, such as Pseudomonas aeruginosa strain LTR1; and a species from the genus Rhodococcus, such as Rhodococcus erythropolis, Rhodococcus aurantiacus, Rhodococcus soli, and Rhodococcus ruber.

In one or more embodiments, the tar-mitigating bacteria may be bacterial species from local, native environments, as candidates that survive and tolerate local reservoir conditions. Thus, local resources are utilized for targeted delivery and accumulation of tar-mitigating bacteria on trapped tar.

The tar-mitigating bacteria may include one or more of the following: plasmid-encoded RNA helicase A (rhlA), rhlB, rhlR, and/or rhlI. The rhl genes of the rhl quorum sensing system are enzymes that catalyze the separation of DNA.

The tar-mitigating bacteria has a growth rate that is based on variables including but not limited to time, nutrients, and food source availability. In one or more embodiments, the concentration of tar-mitigating bacteria in the composition is sufficient to produce an initial biosurfactant concentration of between about 50 to about 500 milligrams per liter (mg/L) of the total composition, such as in a range having a lower limit of any one of 50 mg/L, 60 mg/L, 70 mg/L, 80 mg/L, 90 mg/L, and 100 mg/L, and an upper limit of any one of 300 mg/L, 325 mg/L, 350 mg/L, 375 mg/L, 400 mg/L, 425 mg/L, 450 mg/L, 475 mg/L, and 500 mg/L, where any lower limit can be used with any upper limit. The biosurfactant produced is introduced into the reservoir.

In one or more embodiments, the concentration of tar-mitigating bacteria in the composition is from 70 g/L to 100 g/L. Although the concentration of tar-mitigating bacteria in the composition is sufficient to produce the prescribed concentration of biosurfactant, the concentration of the tar-mitigating bacteria may vary depending on the size of the physical tar barrier and amount of tar in the reservoir, as well as the strength of the biosurfactant.

The tar-mitigating bacteria may be stable under a non-acidic pH range from 7 to 12 pH. Thus, the pH of the composition may range from 7 to 12 pH, such as in a pH range having a lower limit of any of 7 pH, 8 pH, 9 pH, 10 pH, and 11 pH, and an upper limit of any of 8 pH, 9 pH, 10 pH, 11 pH, and 12 pH, where any lower limit can be used with any mathematical allowable upper limit. In one or more embodiments, the pH of the composition is 9 pH.

The tar-mitigating bacteria may be stable under temperatures of from 4° C. to 100° C. In one or more embodiments, the organisms have the ability to produce biosurfactants and grow at temperatures as low as 4° C. A typical temperature range that may be found in a reservoir with a physical tar barrier may be from 60° C. to 90° C.

In one or more embodiments, the tar-mitigating bacteria produce biosurfactants. Such biosurfactants may be a component of the composition, may be produced downhole, or a combination of both.

Biosurfactants are surface-active biomolecules produced by microbes, such as bacteria. Biosurfactants have several advantages over chemical surfactants, such as having lower toxicity, higher biodegradability, pH, and salinity than chemically synthesized counterparts used in conventional methods for mitigating tar.

Microbial biosurfactants are found to have a wide range of applications in environmental protection, which include enhancing oil recovery, controlling oil spills, biodegradation, and detoxification of oil-contaminated industrial effluents and soils.

The produced biosurfactants are amphipathic compounds with both hydrophilic and hydrophobic moieties. Examples of biosurfactants may include but are not limited to rhamnolipids (e.g., C₃₂H₅₈O₁₃), sophorolipids (e.g., C₃₄H₅₈O₁₅), lichenysin, fatty acids (e.g., CH₃(CH₂)ₓCOOH), phospholipids (e.g., CC₃₉H₇₅O₁₀P), neutral lipids (e.g., CH₃(CH₂)nCOOH), polymeric biosurfactants (e.g., —(CH₂—CH₂)n—), and particulate biosurfactants. The aforementioned biosurfactants may be produced by one or more of Azotobacter vinelandii, B. subtilis, Pseudomonas, and Rhodococcus.

The produced biosurfactants may partition at an interface between two or more phases (gas, liquid, and solid) present in a reservoir. The phases may be the same or different phases. The partition at the interface may be between two or more similar phases such as gas/gas, liquid/liquid, solid/solid. The partition at the interface may be between two or more different phases such as gas/liquid, gas/solid, and liquid/solid. The partition at the interface may be between two or more phases same or different phases including but not limited to liquid/solid/gas or liquid/liquid/gas. When a partition at the interface is between two of the same phases it may be between phases having different polarities or hydrogen bonding. For example, when the partition is between liquid/liquid phases, the phases may be oil/water.

Different biosurfactants produced by different types of tar-mitigating bacteria have different biosurfactant strengths related to the strength of biodegradability. For example, strong biosurfactants may include Rhamnolipid produced by Pseudomonas aeruginosa and Sophorolipid, produced by Candida albicans. Weak biosurfactants may include mannosylerythritol lipids and Glycolipoprotein.

In one or more embodiments, the initial concentration of produced biosurfactants is between 100 to 300 mg/L.

The concentration of produced biosurfactants may be sufficient to provide a surface tension between two phases of from 24.7 to 29.6 mN/m, as measured with a tensiometer.

The biosurfactants may be stable under non-acidic pH values (pH 7 to 12) and temperatures up to 100° C.

The composition of one or more embodiments may include a nitrogen source, such as a peptone, a yeast extract, ammonium sulfate, urea, ammonium nitrate, sodium nitrate, potassium nitrate, or any combination thereof. The composition of one or more embodiments may include a salt, such as sodium chloride, potassium chloride, calcium chloride, sodium bisulfate, copper sulfate, or any combination thereof.

The composition may include a lysogeny broth (LB), such as Gibco™ LB Broth (Thermo Fisher Scientific, Waltham, MA, USA), that includes one or more nitrogen sources and a salt.

The concentration of LB may be between 10 to 12 mg/L in the composition.

1 Liter of LB may include from 5 to 15 grams (g) peptone (such as SELECT Peptone 140), such as from 8 to 12 g, or from 9 to 11 g peptone.

Peptones are proteins that have been partially broken down by either acid hydrolysis or by enzymes into short peptides and amino acids.

1 Liter of LB may include from 5 to 15 g yeast extract, such as from 8 to 12 g, or from 9 to 11 g yeast extract.

1 Liter of LB may include from 0.5 to 10 g sodium chloride, such as from 2 to 10 g, 3 to 8 g, or 4 to 6 g sodium chloride.

### Method

Conventional tar-mitigating methods are accomplished by delivering surfactants to a reservoir to change the wettability of the rock surface and interfacial tension between tar and an aqueous phase. Conventional methods may also utilize harsh compositions and methods, such as introducing acidic compositions downhole, to aid in breaking apart tar. Such methods may damage the reservoir, the wellbore, or equipment therein. Conventional methods of using bacteria to produce biosurfactants, including but not limited to microbial enhanced oil recovery (MEOR), enhance oil production from an aged, dead, or almost dead oil reservoir. However, these conventional methods do not efficiently remediate tar as compared to another hydrocarbon source. On the other hand, one or more embodiments of the disclosed method removes tar from a target location in the reservoir, thereby stimulating and breaking up a physical tar barrier present in a reservoir. The concentration of bacteria and other components of the composition that are introduced downhole advantageously mitigate tar over another hydrocarbon when multiple hydrocarbons are present in a reservoir. Tar may also be removed from producer gas at an operating temperature in the range of 35-60° C. with a wet scrubber using a liquid water spray tower. Inherent particulates may also be removed to an allowable amount.

One or more embodiments of the present disclosure is directed to a tar-mitigating bacteria treatment of a reservoir that includes tar, a type of bio-treatment tar mitigation, allowing for the production of biosurfactants in situ from tar-mitigating bacteria rather than injecting surfactants at the surface. The method includes introducing a non-acidic composition. Introducing a non-acidic composition downhole may include advantages such as less damage to the reservoir, wellbore, or equipment therein as compared to conventional methods that do not introduce a non-acidic composition downhole.

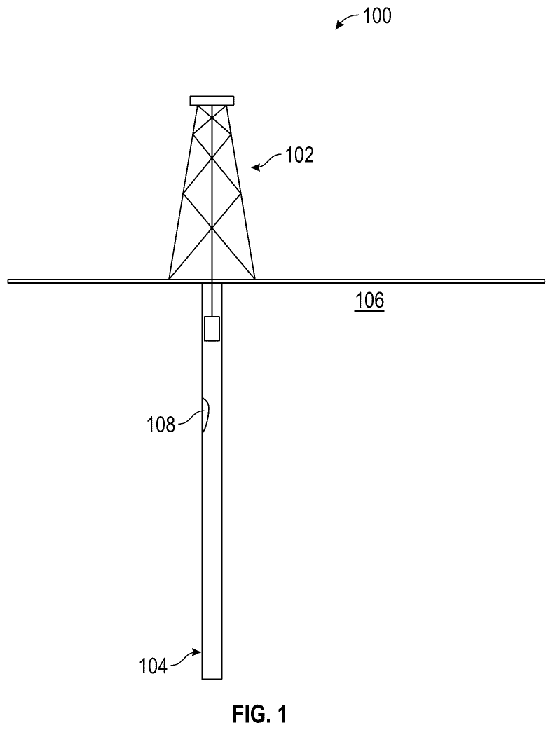

FIG. 1 illustrates one embodiment of a well environment (100) that may include a well (102) having a wellbore (104) extending into a formation (106). The wellbore (104) may include a bored hole that extends from the surface into a target zone of the formation (106), such as a reservoir. In accordance with one or more embodiments, the tar-mitigating bacteria are added to an aqueous biotreatment solution to be introduced downhole. Concentration ranges of tar-mitigating bacteria in the biotreatment solution may be dependent on the bacterial species used. In one or more embodiments, the maximum concentration range for tar-mitigating bacteria in the reservoir is from 10 g/L to 100 g/L.

In one or more embodiments, the reservoir includes a physical tar barrier (108). Tar within the reservoir is a food source for the tar-mitigating bacteria. Bacterial growth is thereby triggered upon reaching the tar food source. When the food source is only tar, it may not be necessary to add an additional food source. The physical tar barrier (108) may have a length of approximately 50 mm to 200 mm, such as 150 mm, an inner diameter of approximately 10 mm to 20 mm, such as 16 mm, and an outer diameter of approximately 10 mm to 30 mm, such as 20 mm.

The tar-mitigating bacteria break apart tar present in the reservoir into smaller fractions of tar or hydrocarbons, resulting from metabolic processes such as biological reactions (bio-cracking). Once broken apart, the smaller fractions of tar mix with water present in the reservoir. Water present in the reservoir may include but is not limited to reservoir water, a waterflood, a composition water of one or more embodiments, and a mixture thereof. The biosurfactants produced by the tar-mitigating bacteria may mobilize the produced tar molecules, thereby producing a liquid tar. Thus, produced liquid tar forms from a combination of the disintegrated (metabolized) tar and the excreted biosurfactants present in the reservoir fluid.

These methods allow autonomous and stimuli-responsive tar-mitigating bacteria that move toward and target trapped tar as a sole carbon food source. Thus, the tar-mitigating bacteria are efficiently targeted toward the trapped tar in the reservoir. When the reservoir is treated with these tar-mitigating bacteria, their ability to trap tar will be higher than bacteria that are not tar-mitigating bacteria. The tar food sources that are trapped are blocked from being ingested by the tar-mitigating bacteria.

Thus, improvements in tar-mitigation efficiency of one or more embodiments are made by replacing synthetic surfactants that are injected into the reservoir with (natural) biosurfactants produced in situ that are target-delivered to the tar that trapped in the reservoir. Advantageously, the same tar-mitigating bacteria that produce the biosurfactants also break apart the tar that is trapped in the reservoir. Breaking apart the tar in the reservoir means that the tar is freed, disintegrated, dissolved, metabolized, or otherwise mobilized from its trapped or fixed position in the reservoir.

In one or more embodiments of the method, nutrients may be added with the tar-mitigating bacteria and introduced downhole. These nutrients may include a nitrogen source, a salt, carbon, phosphate, sulfur, magnesium, iron, potassium, sodium, and calcium. The nitrogen source may include but is not limited to peptone and yeast extract. The salt may include but is not limited to sodium chloride. Additional supplements of nutrients may be added during or after the initial introduction of the tar-mitigating bacteria and composition of one or more embodiments. Introduction of nutrients allows the tar-mitigating bacteria to produce the desired response including maintaining a biosurfactant concentration of from 50 to 500 mg/L at a target location in the reservoir (near the tar or physical tar barrier). For example, the biosurfactant concentration may be in a range having a lower limit of any of 50 mg/L, 60 mg/L, 70 mg/L, 80 mg/L, 90 mg/L, and 100 mg/L, and an upper limit of any of 300 mg/L, 325 mg/L, 350 mg/L, 375 mg/L, 400 mg/L, 425 mg/L, 450 mg/L, 475 mg/L, and 500 mg/L. An introduction downhole may be an injection, such as a water injection.

Biosurfactants produced and released from the tar-mitigating bacteria enable advantageous effects relating to tar mitigation, including lowering or reducing interfacial tension (IFT) between tar and water, altering rock wettability, and, in turn, increasing the capillary number and mobilization of tar (or produced liquid tar). Thus, the method of one or more embodiments removes a physical tar barrier present in the reservoir, thereby improving injectivity into the reservoir (formation).

As previously described, the biosurfactants excreted by the tar-mitigating bacteria partition at the interface between different phases (gas, liquid and solid) and/or between immiscible fluids (oil/water and water/oil). This partitioning effect of the biosurfactants may mobilize hydrocarbons (tar, oil, contaminants, etc.) and further increase their availability for microbial degradation. Solubilization capacity of tar may be improved as a result of biosurfactant aggregation (including but not limited to the formation of micelles). In addition to reducing surface tension and interfacial tension, the bio-surfactants may confer properties to the reservoir fluid such as detergency, and an ability to form an emulsion, foam, or dispersion. In one or more embodiments, the biosurfactant reduces the surface tension of pure water from approximately 72 mN/m to less than 30 mN/m. A force tensiometer may be used to measure interfacial tension by measuring the forces exerted on a probe positioned at a liquid-liquid interface. The probe may be connected with a sensitive balance, and the liquid-liquid interface of interest may be brought into contact with the probe.

Biosurfactants change how water/hydrocarbons behave. When a biosurfactant is added, surface tension is reduced, and water can spread and wet a surface. The produced biosurfactants may act as a detergent. Detergents contain surfactants, or surface-active agents, which work with water/hydrocarbons to loosen dirt and stains, such as in laundry detergent. The produced biosurfactants may act as an emulsifier. An emulsification assay may be used as an indirect method for screening biosurfactant production. If the cell-free culture broth contains biosurfactants and crude oil is used as the hydrophobic substrate, then the cell-free culture broth may emulsify the hydrocarbons present. The produced biosurfactants may act as a foaming agent. The density of foam is expressed by measuring the weight of a single cubic foot of foam material. The produced biosurfactants may act as a dispersant. Standard deviation is a common measure of dispersion, which measures the spread of data about the mean.

Unlike traditional methods, the tar-mitigating bacteria include targeted delivery of the bacteria and the biosurfactants that they produce to parts of the reservoir that would not otherwise be reached by chemical surfactants. Moreover, when the tar-mitigating bacteria reaches the trapped tar, it will produce more biosurfactant directly to be released near the tar, compared to a bacteria that is not a tar-mitigating bacteria. These effects lead to an increase in the mobility of the (trapped) tar. In one or more embodiments, mobilization of remaining tar with the tar-mitigating bacteria occurs in one or more of oil-wet, neutral-wet, and water-wet conditions.

Depending on the strength of the produced biosurfactant, a sufficiently strong biosurfactant may break apart the tar quickly. But, if the produced bio-surfactants are weak, the tar will be broken apart slowly. A strong biosurfactant has one or more compounds that have the ability to remove grease and stains. Additionally, a strong biosurfactant is one that is able to dissolve substances not normally dissolved with only water in a low concentration and in a relatively short period of time. As it relates to the oil and gas industry, a strong biosurfactant may take one to four days to dissolve tar in a reservoir, while a weak biosurfactant may take one to four months to dissolve tar in a reservoir.

The mechanism of biosurfactant action may include mobilizing the produced liquid tar as an emulsion or a mixture of water (aqueous) and tar. Mobilizing the liquid tar may occur with or without further waterflooding. In addition, other hydrocarbons in the reservoir in addition to tar may be mobilized during the step of mobilization. Mobilizing may include displacing and dispersing the tar.

Displacing the tar may include releasing trapped tar from porous media and other entrapped positions in the reservoir rock. Displacing the tar may result from a reduction in interfacial tension when biosurfactants produced by the tar-mitigating bacteria are present, compared to when without biosurfactants produced by the tar-mitigating bacteria. Thus, displacing trapped tar in the manner previously mentioned may relate to reduction of interfacial tension between an aqueous phase and a hydrophobic (tar) phase.

Dispersing the tar may include mobilizing tar in a mixture or an emulsion of aqueous and tar (hydrophobic) phases, where a dispersing step may relate to both a reduction in interfacial tension between phases (aqueous and tar phases) and a concentration of surfactant.

The method of one or more embodiments may include a step of identifying a reservoir that comprises tar. Tar may be identified as a physical tar barrier in a reservoir, which isolates conventional oil that would otherwise be produced from a drilling process if the physical tar barrier was not preset.

The methods presented in one or more embodiments are envisioned to be sustainable. Sustainable methods may include the utilization of native tar-mitigating strains that are available and able to grow under reservoir conditions and may further include minimizing the use of toxic chemicals and other tar-mitigation approaches that cause corrosion and increased acid content compared to the biological approach.

In addition, the methods are cost-effective and less harmful to the environment than other tar-mitigation methods. Methods that are less harmful to the environment generally relate to biocompatibility, biodegradability, and low toxicity or absence of metals in one or more embodiments of the present disclosure.

When the tar is mobilized and forms a produced liquid tar in combination with the biosurfactants, the produced liquid tar may be removed from the reservoir, thereby allowing injectivity pressure to increase compared to when a physical tar barrier is present. In one or more embodiments, the produced liquid tar is removed by further water injection. The liquid tar may be recovered by water injection and washed back from the reservoir to the surface.

Upon mobilizing the tar, the composition and method of one or more embodiments may provide improved transmissibility, sweep efficiency and injectivity pressure maintenance (without pressure drop) resulting in improved waterflooding compared to without the composition or method. Further, the composition and method of one or more embodiments may reduce corrosion as compared to without the composition or method.

Additionally, the composition and method of one or more embodiments allows the breakup of tar (or physical tar barrier) at a considerably greater distance from the wellbore than is practical with mineral acid, or other conventional methods. As previously described, the method of one or more embodiments includes introduction of a non-acidic composition, which is further non-corrosive, non-hazardous, and inert to the reservoir (and well). Thus, equipment costs and personnel safety precautions are reduced compared to conventional methods. As a result, the composition and method of one or more embodiments and products therein are safe to the environment. Advantageously, the composition and method of one or more embodiments may be applied in reservoirs with high temperatures (such as an upper temperature of 100° C.) and high pH (7 to 12).

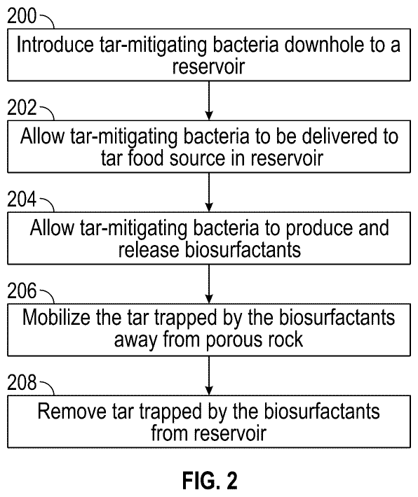

FIG. 2 is a flow diagram illustrating the method for mitigating tar in a reservoir according to one or more embodiments. As described above, tar-mitigating bacteria is introduced downhole to a reservoir in an initial step (200). Then, tar-mitigating bacteria is allowed to be delivered to a tar food source in the reservoir in a second step (202). The tar-mitigating bacteria are allowed to produce and release biosurfactants in a third step (204). In a fourth step (206), tar trapped by the biosurfactants is mobilized away from porous rock. In a final step (208), tar trapped by the biosurfactants is removed from the reservoir.

### EXAMPLES

The following examples are merely illustrative and should not be interpreted as limiting the scope of the present disclosure.

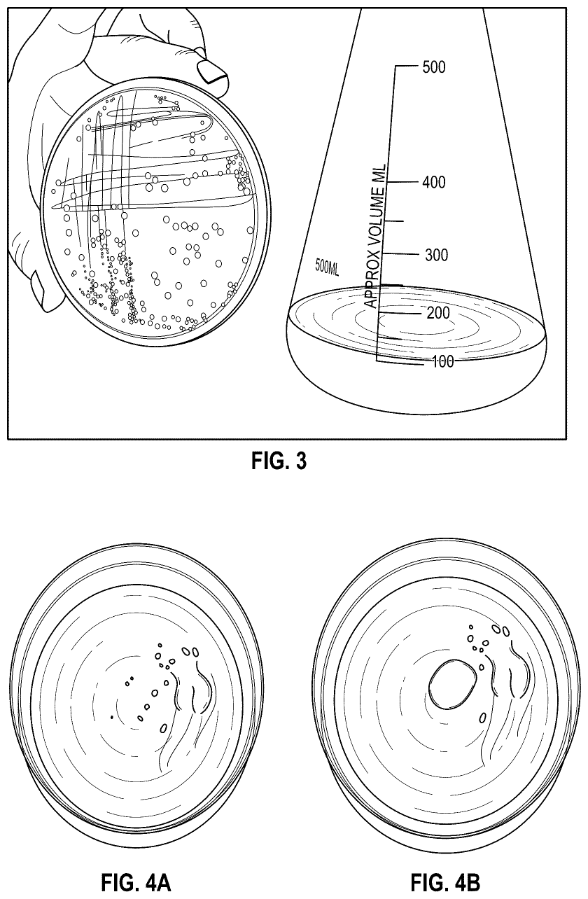

FIG. 3 (right) shows an Erlenmeyer flask with a tar layer including a bacterial composition that comprises tar-mitigating bacteria (Pseudomonas aeruginosa) according to one or more embodiments. The tar-mitigating bacteria were initially grown in an enriched substrate (aqueous fluid) comprising glycerol 4% (w/v) in the flask. FIG. 3 (right) shows the tar in a separate layer from the enriched substrate (aqueous fluid). The tar-mitigating bacteria was collected, isolated from the aqueous fluid, and transferred to a separate container to produce the tar-mitigating bacteria, FIG. 3 (left, aqueous composition). The tar-mitigating bacteria were then grown in a solution of mineral salt, a culture medium, and 4.00 g/L NaNO₃. Subsequently, the isolated strain of tar-mitigating bacteria was allowed to produce Rhamnolipid during growth. A mixture of the produced biosurfactant and the isolated tar-mitigating bacteria was recovered for use in Example 1 and Comparative Example 1, FIG. 3 (left, aqueous composition).

### Comparative Example 1

As shown in FIG. 4A, water and tar were initially added to a dish. Water as a negative control was added to the initial mixture of water and tar, as shown in FIG. 4B. After addition of the negative control, the tar was not mobilized, and the mixture remained unchanged over a period of 24 to 48 hours.

### Example 1

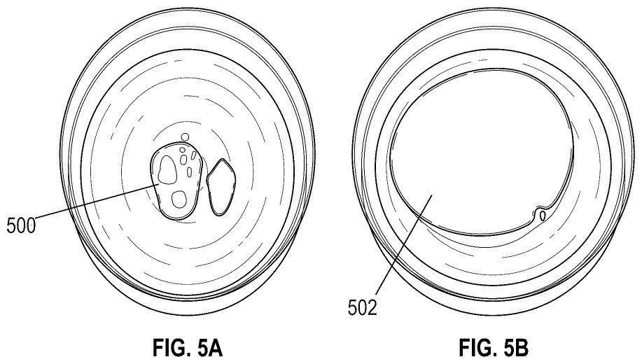

As shown in FIG. 5A, water and tar (500) were initially added to a dish. The tar was sampled from a tar mat having a depth of approximately 2,674 to approximately 2,703 feet, an API of 5.17, and Ø (%): 28.3. An aqueous solution including isolated tar-mitigating bacteria and produced biosurfactant was added to the initial mixture of water and tar, as shown in FIG. 5B. After addition, the tar was mobilized away from the aqueous solution of tar-mitigating bacteria and produced biosurfactant. Further biosurfactant produced by the tar-mitigating bacteria mobilized the tar away from the aqueous solution of tar-mitigating bacteria and produced biosurfactant (502) over a period of 24 to 48 hours.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the words “approximately” or “about” are used, this term may mean that there can be a variance in value of up to ±10%, of up to 5%, of up to 2%, of up to 1%, of up to 0.5%, of up to 0.1%, or up to 0.01%.

The term “substantially” as used refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Ranges may be expressed as from about one particular value to about another particular value, inclusive. When such a range is expressed, it is to be understood that another embodiment is from the one particular value to the other particular value, along with all particular values and combinations thereof within the range.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1-13. (canceled)

14. A method for mitigating tar in a reservoir, comprising:
introducing tar-mitigating bacteria downhole to a reservoir comprising tar;
allowing the tar-mitigating bacteria to be delivered to a tar food source in the reservoir, triggering bacterial growth upon reaching the tar food source, whereupon the tar breaks apart;
allowing the tar-mitigating bacteria to produce and release biosurfactants, thereby trapping the tar from the reservoir with the biosurfactants;
mobilizing the tar trapped by the biosurfactants away from porous rock; and
removing the tar trapped by the biosurfactants from the reservoir.

15. The method of claim 14, wherein the tar food source that is the tar trapped within the reservoir is blocked from being ingested by the tar-mitigating bacteria.

16. The method of claim 14, further comprising identifying a reservoir that comprises tar.

17. The method of claim 14, performed at a temperature of from 4° C. to 100° C.

18. The method of claim 14, further comprising introducing one or more nutrients downhole.

19. The method of claim 18, wherein the one or more nutrients are selected from the group consisting of a nitrogen source, a salt, carbon, phosphate, sulfur, magnesium, iron, potassium, sodium, and calcium.

20. The method of claim 18, wherein the one or more nutrients are introduced during introducing the tar-mitigating bacteria downhole.

21. The method of claim 18, wherein the one or more nutrients are introduced after introducing the tar-mitigating bacteria downhole.

22. The method of claim 14, further comprising maintaining a concentration of the biosurfactants of from 50 mg/L to 500 mg/L at a target location in the reservoir.

23. The method of claim 22, wherein the target location is near a physical tar barrier.

24. The method of claim 14, further comprising forming a produced liquid tar in combination with the biosurfactants when mobilizing the tar and removing the produced liquid tar from the reservoir.
